(19) United States
(12) Patent Application Publication
(10) Pub. No.: US 2026/0246115 A1
(43) Pub. Date: Aug. 20, 2026

(54) SECONDARY BATTERY, CASE FOR SECONDARY BATTERY, AND METHOD OF MANUFACTURING SECONDARY BATTERY

(71) Applicant: SAMSUNG SDI CO., LTD., Yongin-si (KR)

(72) Inventors: Dong Bok YANG, Yongin-si (KR); Joongyong PARK, Yongin-si (KR)

(21) Appl. No.: 19/541,595

(22) Filed: Feb. 17, 2026

(30) Foreign Application Priority Data
Feb. 19, 2025 (KR) 10-2025-0021529

(51) Int. Cl. H01M 50/553; H01M 10/0525; H01M 50/103; H01M 50/105

(52) U.S. Cl. CPC H01M 50/553; H01M 10/0525; H01M 50/103; H01M 50/105

(57) ABSTRACT

A secondary battery includes a body comprising an accommodation space, with an opening being formed in the body. An electrode assembly is provided in the accommodation space, with the electrode assembly including a first electrode, a separator, and a second electrode. A cover is coupled to the body to cover the opening. A notch groove formed on at least one of an inner surface of the body and an inner surface of the cover. The notch groove is configured to fracture induce the at least one of the inner surface of the body and the inner surface of the cover to fracture when a predetermined internal pressure of the accommodation space is reached.

### CROSS-REFERENCE TO RELATED APPLICATION

This application claims priority under 35 U.S.C §119 to Korean Patent Application No. 10-2025-0021529, filed in the Korean Intellectual Property Office on February 19, 2025, the entire contents of which are hereby incorporated by reference.

### BACKGROUND

### TECHNICAL FIELD

The present disclosure relates to a secondary battery, a case for the secondary battery, and a method of manufacturing the secondary battery.

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The cases of secondary batteries used in small electronic devices have been formed from aluminum alloys in view of light weight, formability, and economy. However, an aluminum case may be damaged for many reasons during various processes. Accordingly, technology for a SUS-can-type secondary battery that uses stainless use steel (SUS) instead of aluminum has been researched.

When a secondary battery is exposed to a high-temperature environment or when a short circuit occurs, gas may be generated inside the case by electrolyte decomposition or electrode reactions. As a result, swelling may occur as the case bulges. The case of the secondary battery may then rupture, and ignition or explosion caused by thermal runaway may occur.

The above information disclosed in this Background section is for enhancement of understanding of the background of the present disclosure, and therefore, it may contain information that does not constitute related (or prior) art.

### SUMMARY

The present disclosure provides a secondary battery, a case for the secondary battery, and a method of manufacturing the secondary battery that are capable of solving the above-described technical problems.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

Aspects of embodiments provide a secondary battery including a body comprising an accommodation space, with an opening being formed in the body, an electrode assembly provided in the accommodation space of the body, the electrode assembly including a first electrode, a separator, and a second electrode, a cover coupled to the body to cover the opening, and a notch groove formed in at least one of an inner surface of the body and an inner surface of the cover, wherein the notch groove is configured to induce the at least one of the inner surface of the body and the inner surface of the cover to fracture when a predetermined internal pressure of the accommodation space is reached.

In some embodiments, the body may include a first surface adjacent to the electrode assembly and a second surface opposite to the first surface, and the notch groove is formed in the first surface and toward the second surface.

In some embodiments, when the internal pressure of the accommodation space is greater than or equal to a predetermined pressure, the body may be fractured at an end portion of the notch groove adjacent to the second surface.

In some embodiments, the cover may include a third surface adjacent to the electrode assembly and a fourth surface opposite to the third surface, and the notch groove is formed in the third surface and toward the fourth surface.

In some embodiments, when the internal pressure of the accommodation space is greater than or equal to a predetermined pressure, the cover may be fractured at an end portion of the notch groove adjacent to the fourth surface.

In some embodiments, a cross-sectional shape of the notch groove may be a triangle, a rectangle, a trapezoid, or an arc.

In some embodiments, the notch groove may include at least one notch groove formed along a straight line extending in a first direction on a plane of the cover or along a straight line extending in a second direction on the plane of the cover.

In some embodiments, the notch groove may include a plurality of notch grooves arranged at positions that are symmetric with respect to an axis passing through a central portion of the plane of the cover.

In some embodiments, a front-view shape of the notch groove may be at least one of a curved shape and a linear shape.

In some embodiments, a depth of the notch groove may be greater than or equal to 50 percent and less than or equal to 90 percent of a thickness of the cover.

In some embodiments, the body and the cover may be formed of the same metallic material.

In some embodiments, the metallic material may include stainless use steel.

Aspects of embodiments provide a case for a secondary battery including a body comprising an accommodation space configured to receive an electrode assembly, a cover coupled to the body to cover the opening, and a notch groove formed in at least one of an inner surface of the body and an inner surface of the cover, wherein the notch groove is configured to induce the at least one of the inner surface of the body and the inner surface of the cover to fracture when an predetermined pressure of the accommodation space is reached.

In some embodiments, the body may include a first surface adjacent to the electrode assembly and a second surface opposite to the first surface, and the notch groove is formed by notching in the first surface and toward the second surface.

In some embodiments, when the internal pressure of the accommodation space is greater than or equal to the predetermined internal pressure, the body is fractured an end portion of the notch groove adjacent to the second surface may fracture.

In some embodiments, the cover may include a third surface adjacent to the electrode assembly and a fourth surface opposite to the third surface, and the notch groove may be formed in the third surface and toward the fourth surface.

In some embodiments, when the internal pressure of the accommodation space is greater than or equal to the predetermined internal pressure, the cover is fractured at an end portion of the notch groove adjacent to the fourth surface may fracture.

Aspects of embodiments provide a method of manufacturing a secondary battery including forming a notch groove on at least one of an inner surface of a body and an inner surface of a cover, inserting an electrode assembly into an accommodation space of the body, and coupling the cover to the body to cover an opening formed in the body.

In some embodiments, the body may include a first surface adjacent to the electrode assembly and a second surface opposite to the first surface, and forming the notch groove may include notching in a direction from the first surface toward the second surface to form the notch groove in the inner surface of the body.

In some embodiments, the cover may include a third surface adjacent to the electrode assembly and a fourth surface opposite to the third surface, and forming the notch groove may include notching in a direction from the third surface toward the fourth surface to form the notch groove in the inner surface of the cover.

According to some embodiments of the present disclosure, when internal pressure inside the body of the secondary battery is greater than or equal to a certain level, the body may fracture because of the notch groove and, upon fracture, the body and/or cover may open in a direction opposite a surface adjacent to the electrode assembly. Therefore, when the electrode assembly swells and the body and/or cover is fractured by the notch groove, a problem in which a short occurs between the electrode assembly and a fragment of the body or the cover may be prevented.

According to some embodiments of the present disclosure, by forming the notch groove in the body or the cover, thermal runaway due to an internal-pressure increase caused by abnormal behavior of the secondary battery may be prevented without additional parts, thereby improving safety of the secondary battery.

According to some embodiments of the present disclosure, the notch groove may be disposed in the body or in the cover in consideration of a position where the electrode assembly abnormally expands, and gas in the accommodation space may be rapidly discharged with low resistance, thereby preventing an explosion of the secondary battery.

According to some embodiments of the present disclosure, when the body/cover fractures, gas in the accommodation space may be discharged at once, thereby efficiently reducing internal pressure of the accommodation space and preventing an explosion of the secondary battery.

According to some embodiments of the present disclosure, by forming the cross-sectional shape and depth of the notch groove to facilitate fracture, uniform rupture may be induced while maintaining a necessary strength of the secondary battery in a normal state.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is an exploded perspective view of a secondary battery according to an embodiment of the present disclosure.

FIG. 2 is a perspective view of a secondary battery according to an embodiment of the present disclosure.

FIG. 3 is a cross-sectional view illustrating fracture at a notch groove caused by electrode-assembly expansion in a comparative example.

FIG. 4 is a cross-sectional view illustrating fracture at a notch groove caused by electrode-assembly expansion according to an embodiment of the present disclosure.

FIG. 5 is a cross-sectional view at the notch groove according to an embodiment of the present disclosure.

FIG. 6 is a schematic view of a state in which the electrode assembly is received in the case for a secondary battery according to an embodiment of the present disclosure.

FIG. 7 is a view of a notch groove formed on a first surface of the body according to an embodiment of the present disclosure.

FIG. 8 is a view of a notch groove formed on a third surface of the cover according to an embodiment of the present disclosure.

FIG. 9 is a view of another example of the notch groove formed on the third surface of the cover according to an embodiment of the present disclosure.

FIG. 10 is a view of another example of notch grooves formed symmetrically on the third surface of the cover according to an embodiment of the present disclosure.

FIG. 11 is a view of an example in which a front-view shape of the notch groove is curved according to an embodiment of the present disclosure.

FIG. 12 is a view of an example in which a front-view shape of the notch groove is linear according to an embodiment of the present disclosure.

FIG. 13 is a view of another example in which a front-view shape of the notch groove is linear according to an embodiment of the present disclosure.

FIG. 14 is a view of yet another example in which a front-view shape of the notch groove is linear according to an embodiment of the present disclosure.

FIG. 15 is a view of another example in which a front-view shape of the notch groove is curved according to an embodiment of the present disclosure.

FIG. 16 is a view of the depth of the notch groove according to an embodiment of the present disclosure.

FIG. 17 is a view of an example in which a cross-sectional shape of the notch groove is rectangular according to an embodiment of the present disclosure.

FIG. 18 is a view of an example in which a cross-sectional shape of the notch groove is trapezoidal according to an embodiment of the present disclosure.

FIG. 19 is a view of an example in which a cross-sectional shape of the notch groove is arcuate according to an embodiment of the present disclosure.

FIG. 20 is a flowchart of a method of manufacturing the secondary battery according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

The terminology used herein is for the purpose of describing embodiments of the present disclosure and is not intended to be limiting of the present disclosure.

Singular expressions in this specification include plural expressions unless singularity is clearly specified, and plural expressions include singular expressions unless plurality is clearly specified. Where a part is described as including a component, the description does not exclude additional components unless a contrary description is present.

Layers and regions shown in the drawings may be exaggerated in size or relative size for clarity. Sizes shown are for ease of understanding and are not limiting. Identical reference numerals throughout the specification denote identical components.

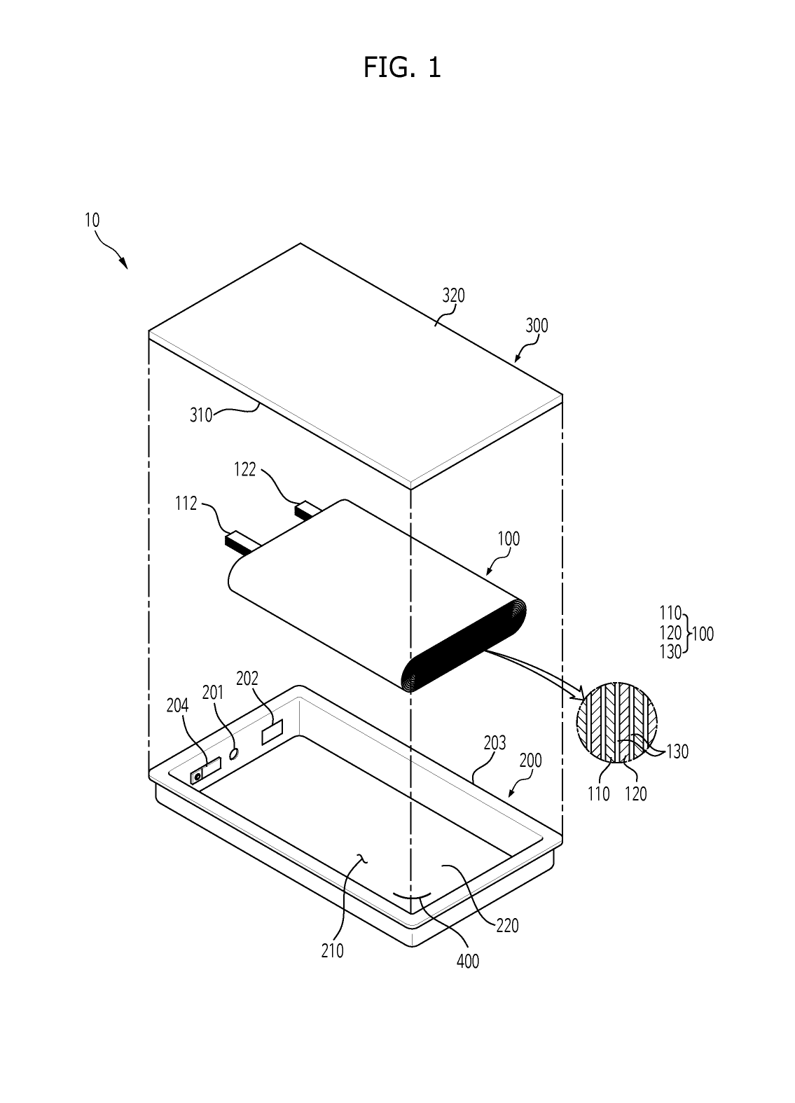

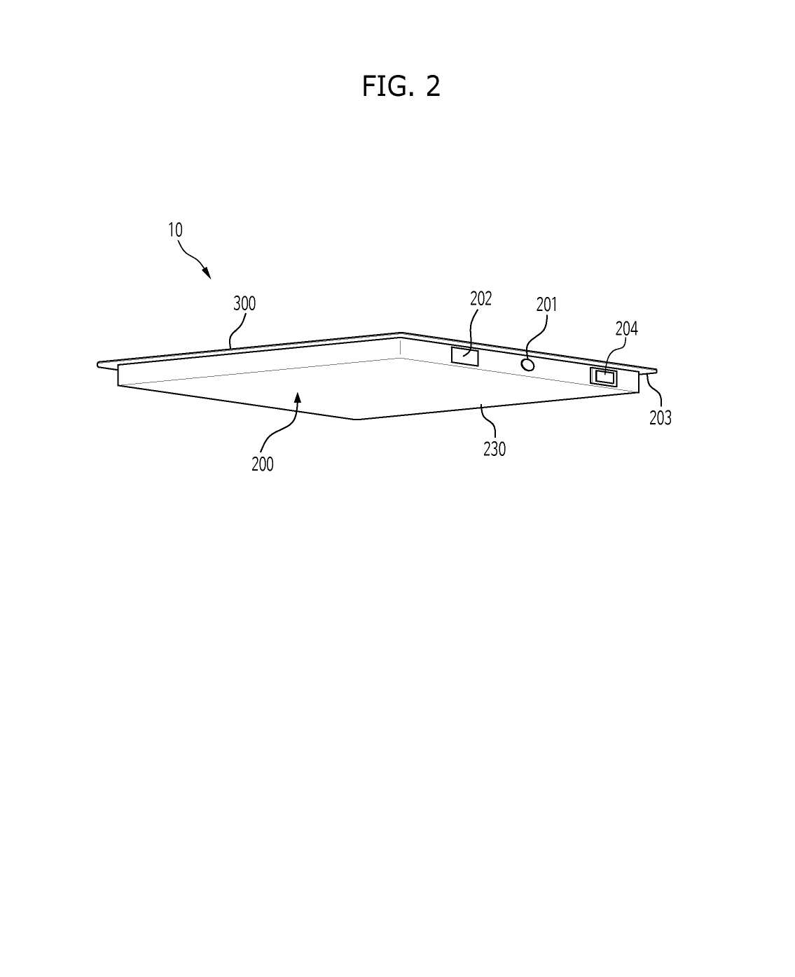

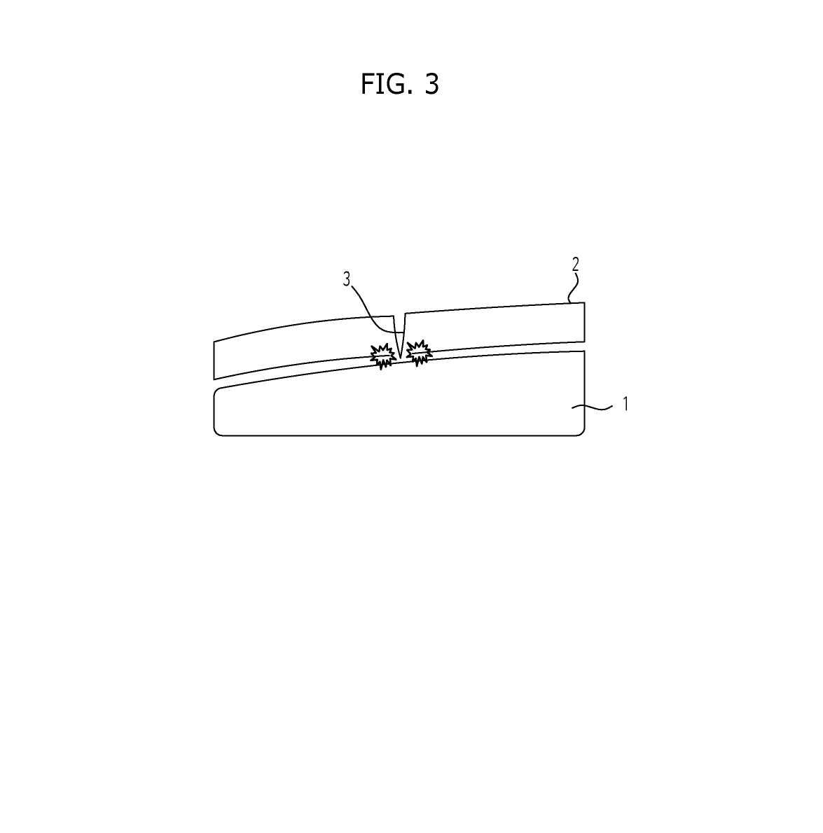

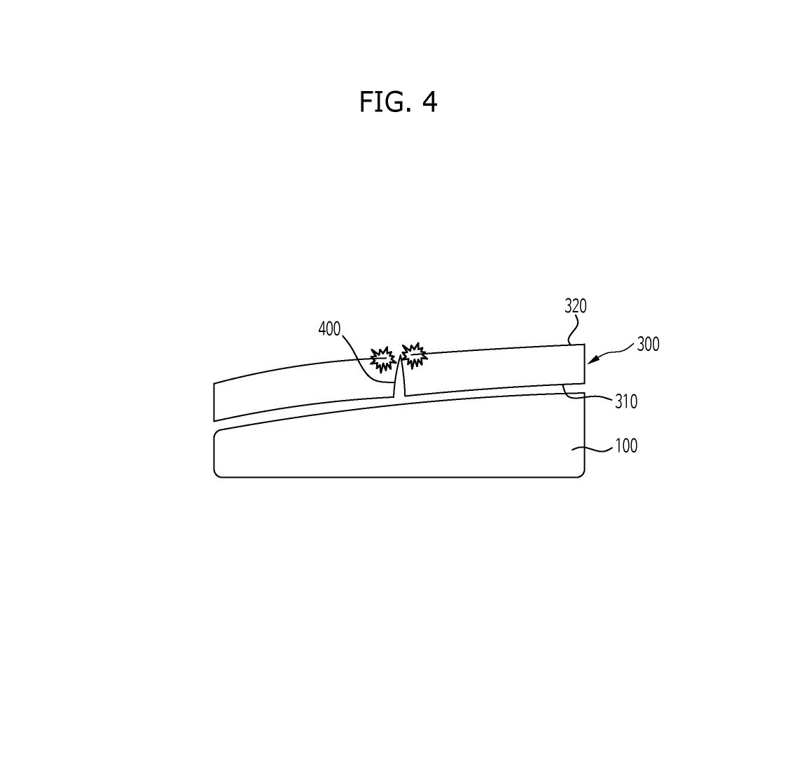

FIG. 1 is an exploded perspective view of a secondary battery according to an embodiment, FIG. 2 is a perspective view of the secondary battery, FIG. 3 is a cross-sectional view of a notch groove caused by electrode-assembly expansion in a comparative example, and FIG. 4 is a cross-sectional view illustrating fracture of a notch groove caused by electrode-assembly expansion in an embodiment.

Referring to FIGS. 1 and 2, the secondary battery 10 may include an electrode assembly 100, a body 200 that defines an accommodation space 210 receiving the electrode assembly 100, a cover 300 coupled to the body 200. The secondary battery 10 may also include a notch groove 400 configured to fracture by internal pressure of the accommodation space 210.

The electrode assembly 100 may include a first electrode 110, a separator 130, and a second electrode 120. For example, the electrode assembly 100 may be wound or stacked with the separator 130 interposed between the first electrode 110 and the second electrode 120. The first electrode 110 may include a first substrate and a first active-material layer located on the first substrate. A first electrode tab 112 may extend outward from a first non-coated region of the first substrate where the first active-material layer is not provided. The second electrode 120 may include a second substrate and a second active-material layer located on the second substrate. A second electrode tab 122 may extend outward from a second non-coated region of the second substrate where the second active-material layer is not provided. The first electrode 110 may function as a positive electrode. In such a case, the first substrate may be a positive-electrode substrate. The positive-electrode substrate may be formed of an aluminum foil, and the positive-electrode active material may include, for example, a transition-metal oxide.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a high nickel-based positive electrode active material having a nickel content of greater than or equal to about 80 mol%, greater than or equal to about 85 mol%, greater than or equal to about 90 mol%, greater than or equal to about 91 mol%, or greater than or equal to about 94 mol% and less than or equal to about 99 mol% based on 100 mol% of the metal excluding lithium in the lithium transition metal composite oxide. The high-nickel-based positive electrode active material may be capable of realizing high capacity and can be applied to a high-capacity, high-density rechargeable lithium battery.

The second electrode 120 may function as a negative electrode. In such a case, the second substrate may be a negative-electrode substrate. The negative-electrode substrate may be formed, for example, of a copper foil or a nickel foil, and the negative-electrode active material may include, for example, graphite. The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0 < x < 2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The separator 130 may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON®, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃,SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

The body 200 may have one open end and define the accommodation space 210 that receives the electrode assembly 100. The electrode assembly 100 may be inserted through the open end of the body 200 and received in the accommodation space 210. The cover 300 may be coupled to the body 200 to seal the accommodation space 210.

In an embodiment, the body 200 may have the open end that receives the electrode assembly 100, and the negative-electrode terminal 202 and the positive-electrode terminal 204 may be disposed at a side of the body 200 that is different from the open end. The body 200 may include an electrolyte-injection port 201. The electrolyte-injection port 201 may be a through-hole formed in a side surface of the body 200. The electrolyte-injection port 201 may be configured such that electrolyte can be injected through the electrolyte-injection port 201 into the body 200 after the body 200 and the cover 300 are joined and sealed. After the electrolyte is injected, the electrolyte-injection port 201 may be sealed with a sealing member. Although the electrolyte-injection port 201 is shown between a pair of electrode terminals, the position is not limited thereto and may the electrolyte-injection port 201 may be provided at various other positions.

The pair of electrode terminals may be disposed on the side surface of the body 200. For example, the negative electrode terminal 202 and the positive electrode terminal 204 may be disposed on both sides of the electrolyte injection port 201.

The positive-electrode terminal 204 may be electrically connected to the first electrode tab 112 of the electrode assembly 100, and the negative-electrode terminal 202 may be electrically connected to the second electrode tab 122 of the electrode assembly 100. Positions of the positive-electrode terminal 204 and the negative-electrode terminal 202 are not limited to those depicted in FIG. 1 and may vary.

An accommodation space 210 for receiving the electrode assembly 100 may be formed at an approximately central region of the body 200 by a pressing process or the like. A flange 203 may be formed to extend outward in four directions around the upper edge of the accommodation space.

The cover 300 may be coupled to the open end of the body 200. The body 200 and the cover 300 may be joined to form an outer appearance of the secondary battery 10. For example, the cover 300 may be a plate that is disposed on an upper portion of the body 200 so as to seal the accommodation space 210 of the body 200. The cover 300 may be sized large enough to cover the flange 203 and may be in contact with the flange 203.

The body 200 and the cover 300 may be metal-joined, such as by welding, brazing, or soldering. In the depicted embodiment, the flange 203 of the body 200 and an edge of the cover 300 may be joined. After the body 200 and the cover 300 are joined, at least part of the flange 203 may be cut by a laser to increase energy density of the secondary battery 10. Although the body 200 with the flange 203 is depicted in the drawings, the body 200 may be coupled to the cover 300 without the flange 203.

The body 200 and the cover 300 may be formed from the same metallic material. By forming the body 200 and the cover 300 from the same material, corrosion at a portion where the body 200 and the cover 300 are joined that would be caused by a potential difference between dissimilar metals may be prevented.

The metallic material forming the body 200 and the cover 300 may include stainless use steel SUS. Depending on kinds and ratios of alloying elements, the stainless-steel material may be SUS 304, SUS 316, SUS 420, SUS 430, or another stainless-steel series material.

In an example, the body 200 and the cover 300 shown in FIG. 1 may include stainless steel (SUS), meaning the secondary battery 10 may be a SUS-can-type secondary battery. But the present disclosure is not limited thereto. For example, the body 200 and the cover 300 may be formed of a conductive metal such as aluminum, an aluminum alloy, or nickel-plated steel to form an outer appearance of the secondary battery 10.

The secondary battery 10 may be a lithium battery cell or a sodium battery cell. However, the scope of the present disclosure is not limited to particular types of batteries, and the secondary battery 10 may include any kind of battery that repeatedly supplies electricity by charging and discharging.

The secondary battery 10 may include the notch groove 400 formed on at least one of the inner surface of the body 200 and the inner surface of the cover 300. The notch groove 400 may be configured to cause a fracture by internal pressure of the accommodation space 210. The notch groove 400 may be formed by laser etching from the inside of the body 200, or the notch groove 400 may be formed by laser etching from the inside of the cover 300.

When the body 200 and the cover 300 are formed from stainless steel (SUS), rigidity of the body 200 and cover 300 may be increased as compared to a body and cover formed from materials such as aluminum or iron. Thus, it is possible to make a case for the secondary battery having the desired strength while reducing the thickness of the body 200 and the cover 300, thereby increasing the energy efficiency of the secondary battery 10. Moreover, damage caused by melting of the body 200 and the cover 300 by high-temperature gas or by-products discharged through the notch groove 400 may be prevented.

The body 200 may include the first surface 220 adjacent to the electrode assembly 100 and the second surface 230 opposite the first surface 220. The notch groove 400 may be formed by notching from the first surface 220 toward the second surface 230 of the body 200. When the internal pressure of the accommodation space 210 is greater than or equal to a predetermined pressure, a portion of the body adjacent to the notch groove 400 and the second surface 230 may fracture.

The cover 300 may include the third surface 310 adjacent to the electrode assembly 100 and the fourth surface 320 opposite the third surface 310. The notch groove 400 may be formed by notching from the third surface 310 toward the fourth surface 320 of the cover 300 such that the notch is positioned inside the case when the cover 300 is provided to the body 200. When the internal pressure of the accommodation space 210 is greater than or equal to a predetermined pressure, the cover adjacent to an end of the notch groove 400 and the fourth surface 320 may fracture.

In a comparative example, as shown in FIG. 3, a notch groove 3 may be formed by notching from an outer surface of a cover 2 toward an inner surface. In such an arrangement where the notch groove 3 is formed toward the inner surface of the cover 2 adjacent to an electrode assembly 1, when there is a fracture caused by the notch groove 3 and expansion of the electrode assembly 1 a fragment of the cover 2 may move toward the electrode assembly 1. This fragment generated by fracture at the notch groove 3 may be directed into the secondary battery and may physically damage the electrode assembly 1.

According to an embodiment and as shown in FIG. 4, the notch groove 400 formed in the body 200 or the cover 300 may open, upon fracture, in a direction away from a surface adjacent to the electrode assembly 100. Therefore, when gas is discharged due to an abnormality of the secondary battery, a fragment of a portion where the fracture occurs does not move into the secondary battery because a discharge direction of the gas and a fracture direction of the notch groove 400 coincide. Accordingly, when the electrode assembly 100 swells and the notch groove 400 causes a fracture, problems such as a short occurs between the electrode assembly 100 and a fragment of the body 200 or the cover 300 may be prevented.

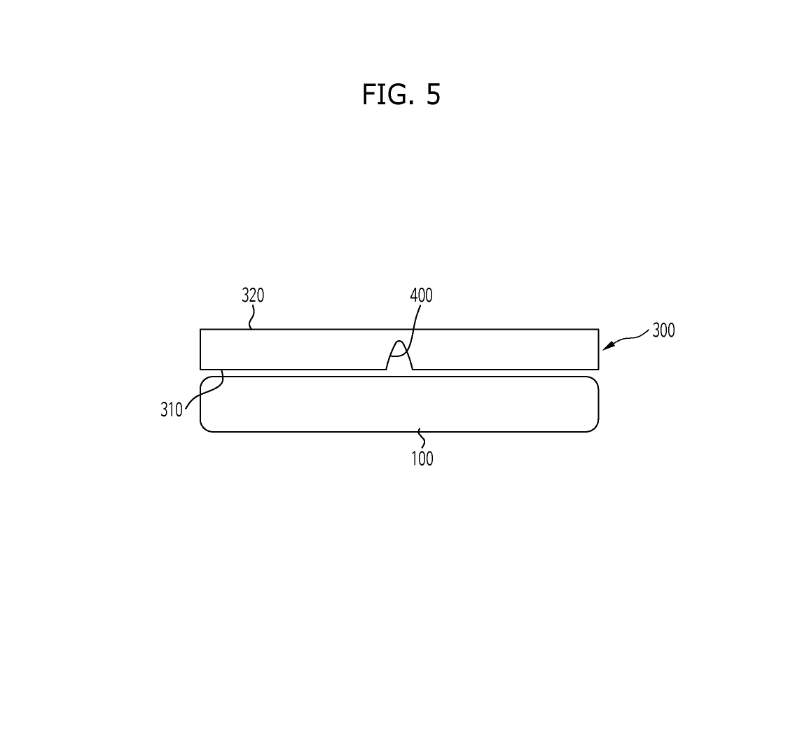

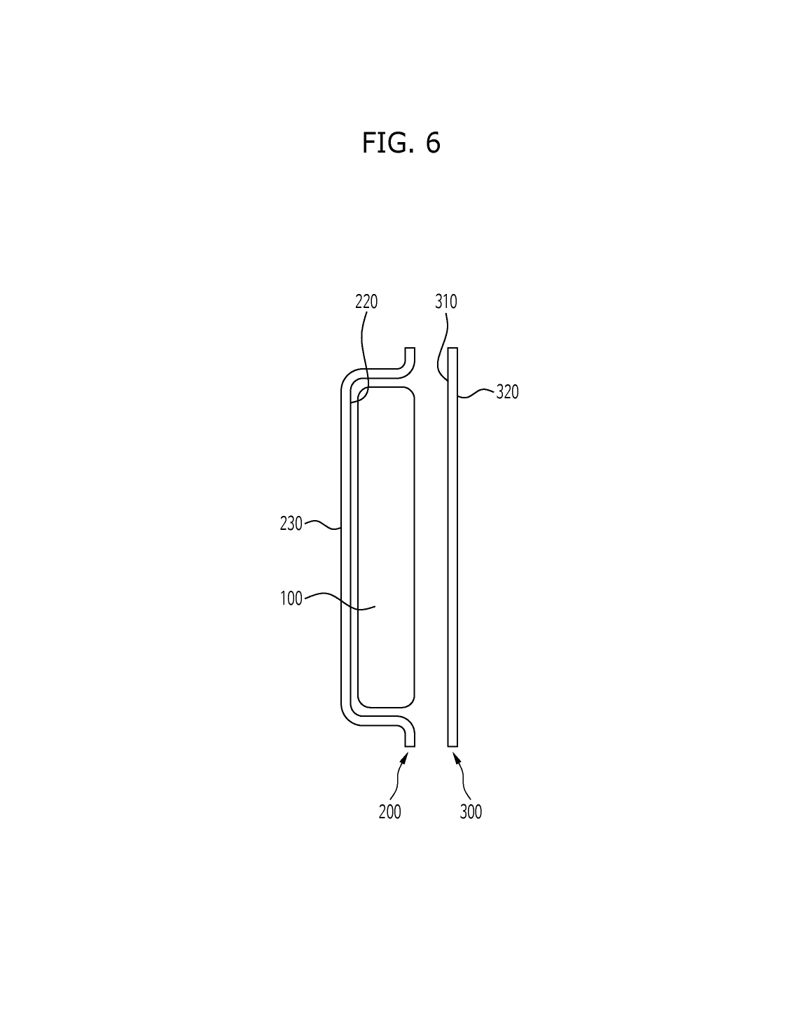

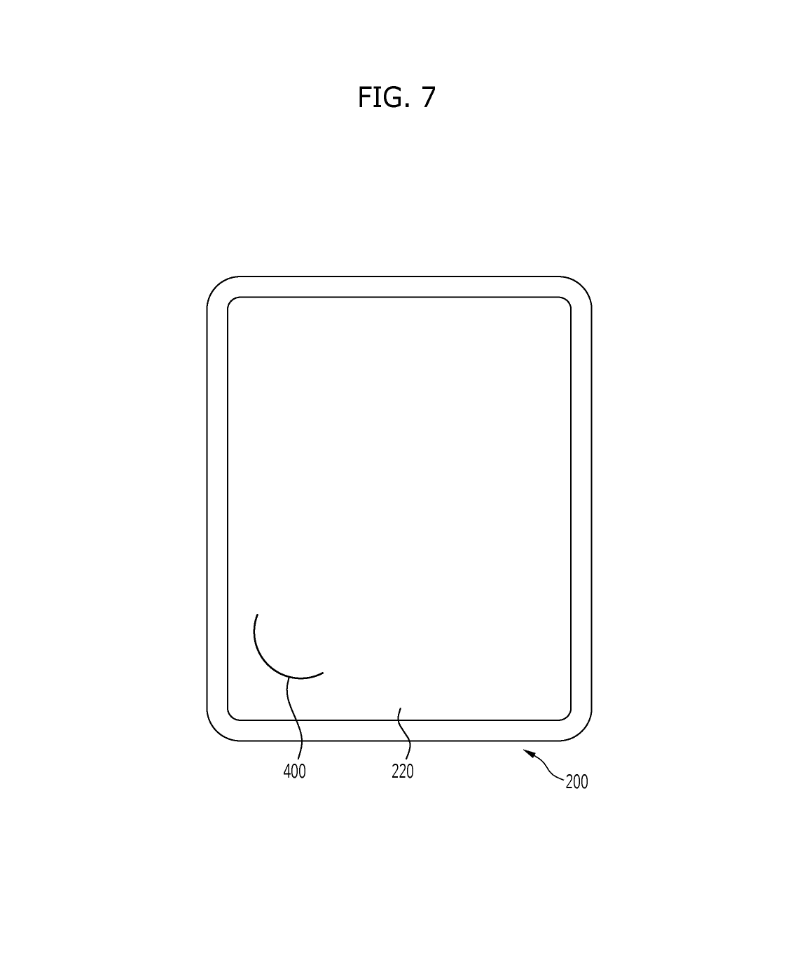

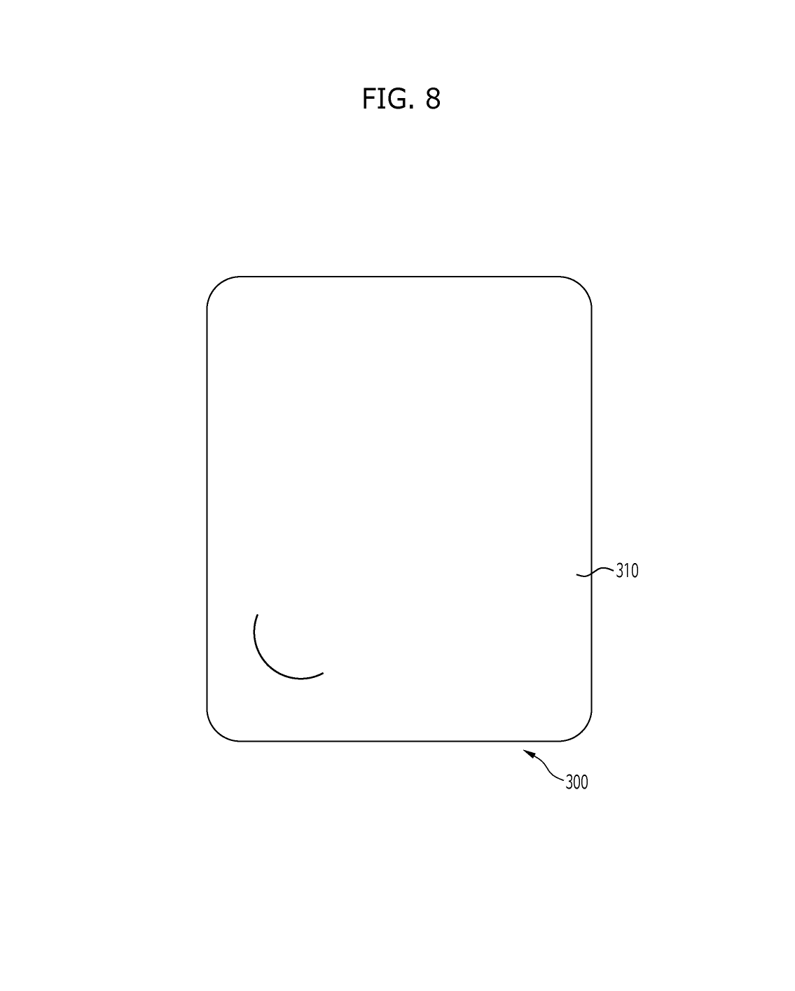

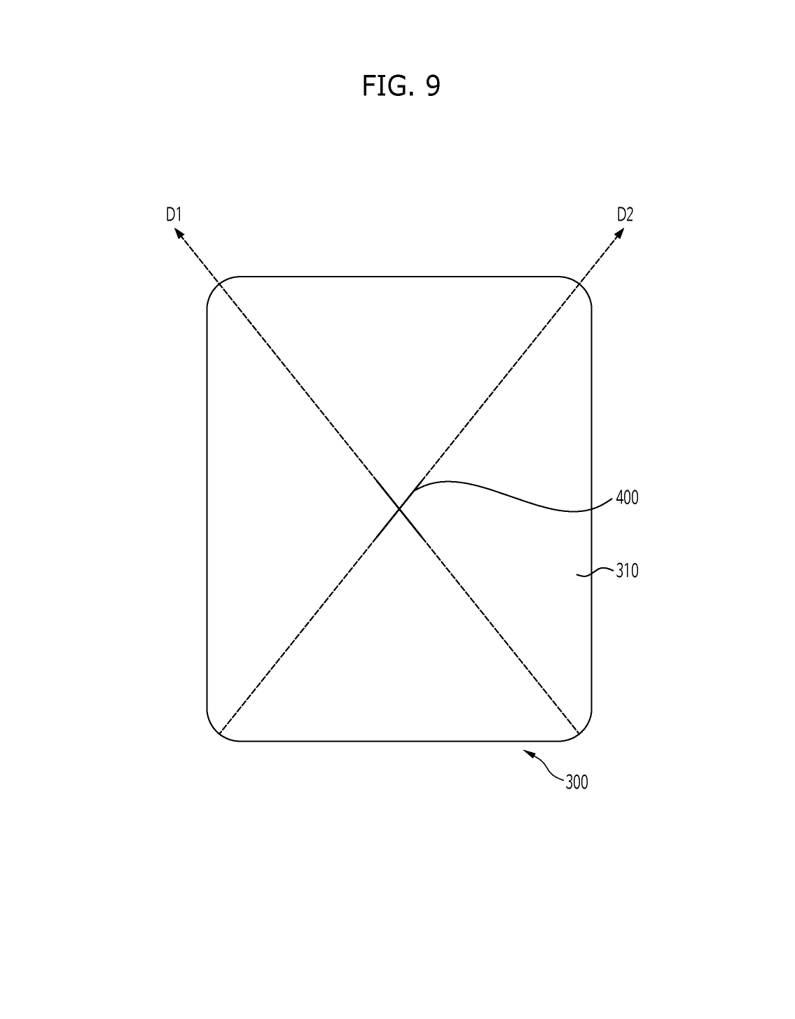

FIG. 5 is a cross-sectional view of the notch groove according to an embodiment of the present disclosure, FIG. 6 is a schematic view showing a state in which the electrode assembly is received in the case for the secondary battery according to an embodiment of the present disclosure, FIG. 7 is a view of the notch groove formed on the first surface of the body according to an embodiment of the present disclosure, FIG. 8 is a view of the notch groove formed on the third surface of the cover according to an embodiment of the present disclosure, and FIG. 9 is a view of another example of the notch groove formed on the third surface of the cover according to an embodiment of the present disclosure.

The cross-sectional shape of the notch groove 400 may be triangular. The cross-sectional shape of the notch groove 400 is not limited as long as the shape can effectively induce a fracture. In the example depicted in FIG. 5, when the cross-sectional shape of the notch groove 400 is triangular, a uniform fracture may be induced by a crack at an upper end of the notch groove 400. That is, when the internal pressure of the body 200 rises above a predetermined pressure, the body 200 adjacent to an end portion of the notch groove 400 and the fourth surface 320 may uniformly fracture, thereby enabling easy gas discharge.

The notch groove 400 may be formed both in the body 200 and the cover 300 or may be formed in only one of the body 200 and the cover 300. In particular embodiments, the notch groove 400 may be formed on the inner surfaces of the body 200 and the cover 300 so that a fracture fragment does not physically act on the electrode assembly 100. As described above, the notch groove 400 may be formed by notching from the first surface 220 toward the second surface 230 of the body 200. Further, the notch groove 400 may be formed by notching from the third surface 310 toward the fourth surface 320 of the cover 300.

In the embodiment depicted in FIG. 7, the notch groove 400 may be formed at a side-edge portion on the first surface 220 of the body 200. Also, as shown in the embodiment depicted in FIG. 8, the notch groove 400 may be formed at a side-edge portion on the third surface 310 of the cover 300. When a high pressure is reached inside the secondary battery, high stress is applied to the side edge area of the secondary battery case, and the internal pressure can be effectively relieved by rapid gas discharge through the fracture induced by the notch groove 400.

The notch groove 400 may be formed along a straight line extending in the first direction D1 on the plane of the cover 300 or along a straight line extending in the second direction D2 on the plane of the cover 300. For example, as shown in FIG. 9, the notch groove 400 may be along straight lines that intersect at a position where the first direction D1 and the second direction D2 intersect on the third surface 310 of the cover 300. In this configuration, when the center of the electrode assembly expands and the case for the secondary battery swells due to a rise in internal pressure, the notch groove 400 may efficiently induce fracture at a central portion of the cover 300 that is subjected to high stress.

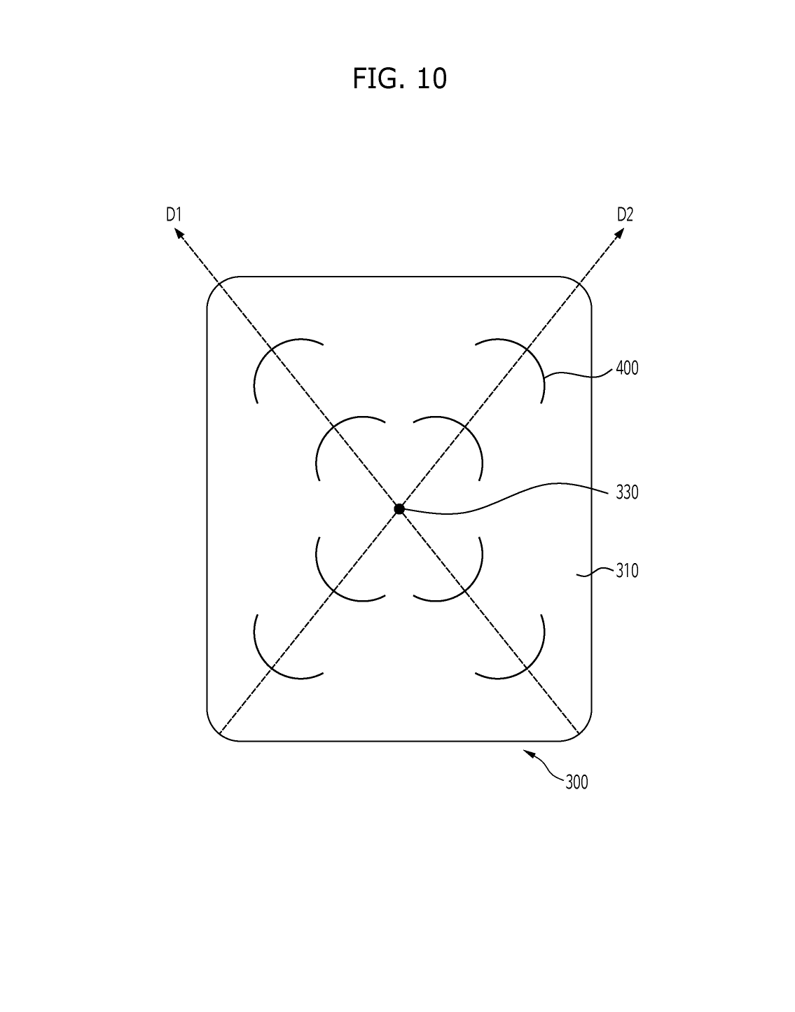

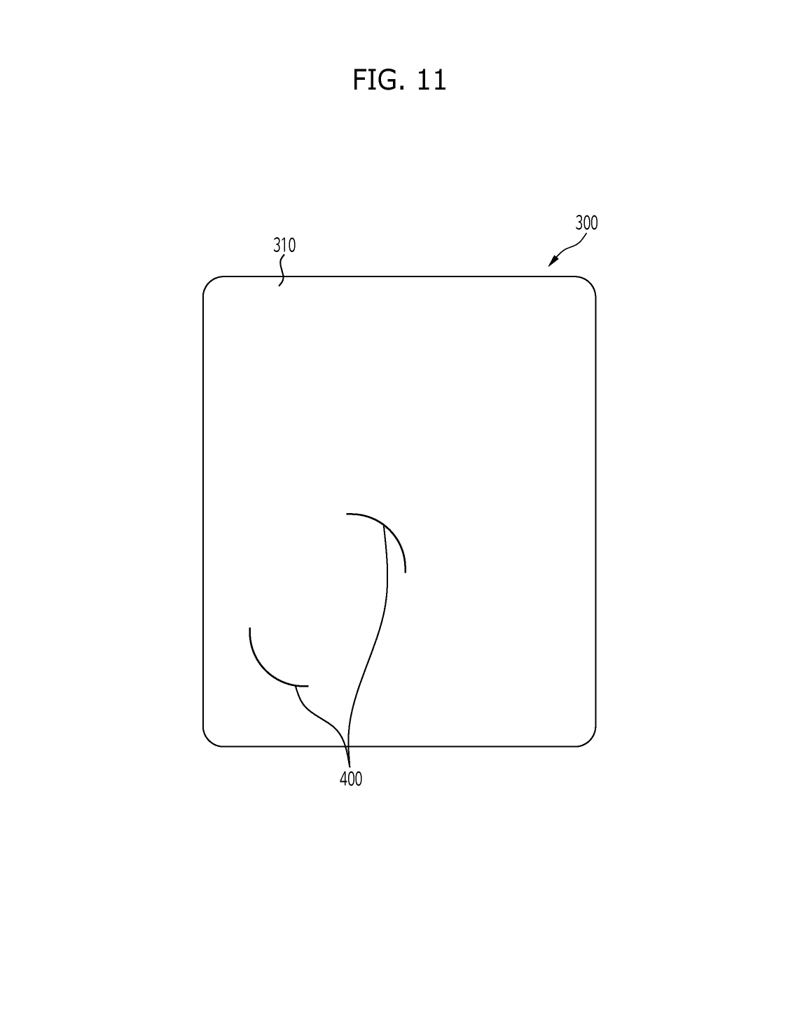

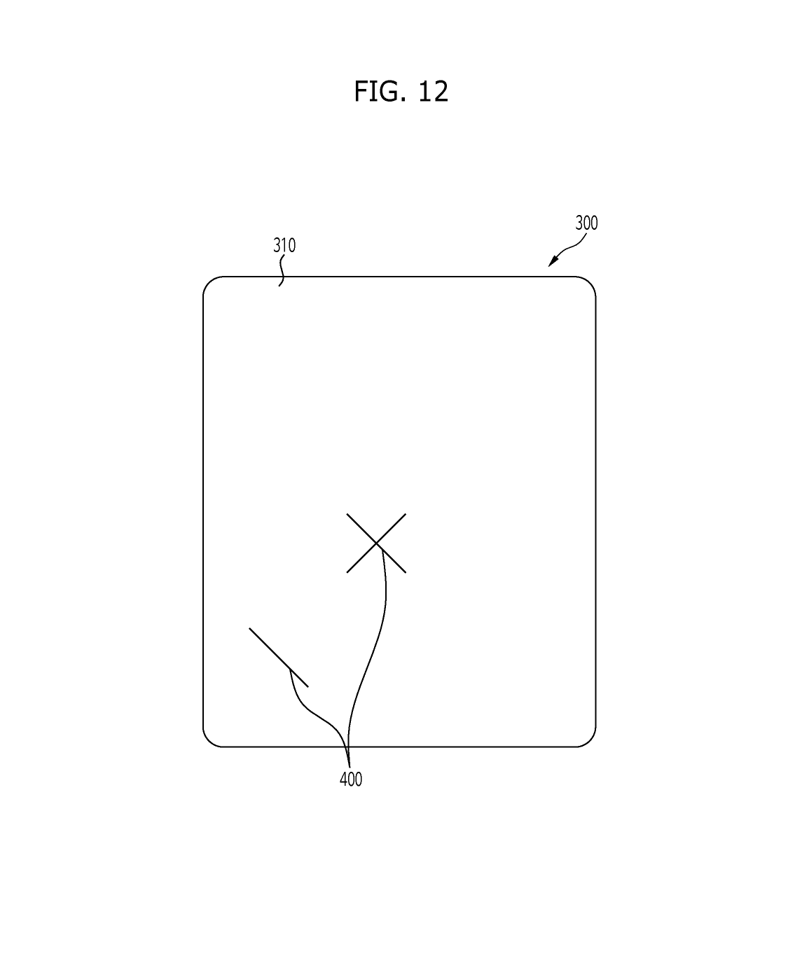

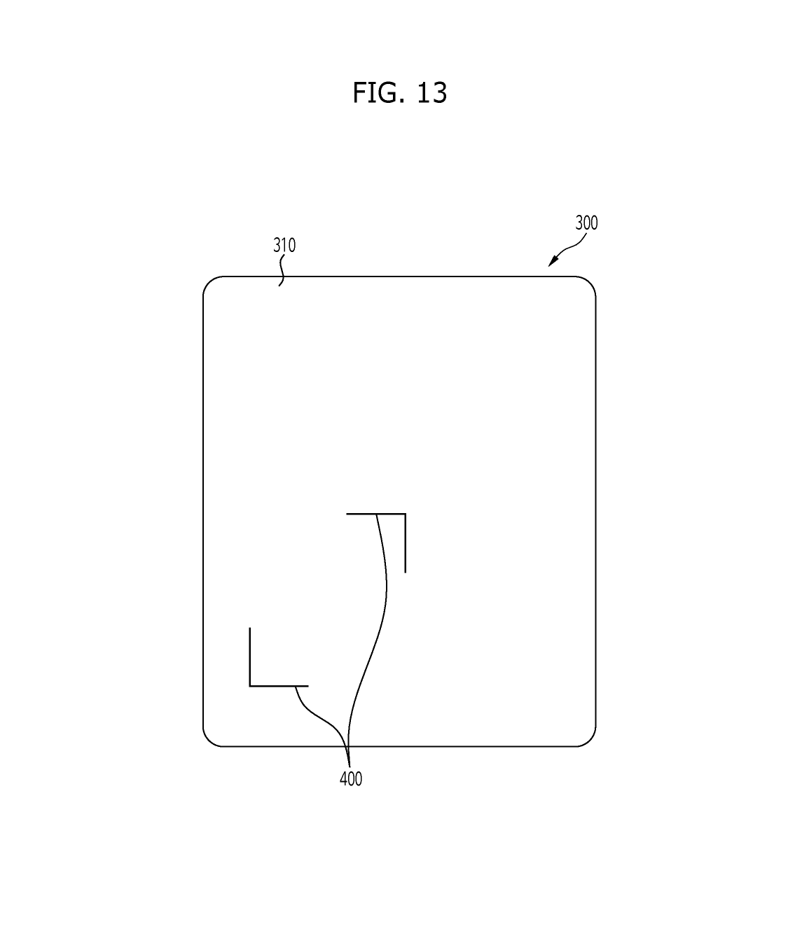

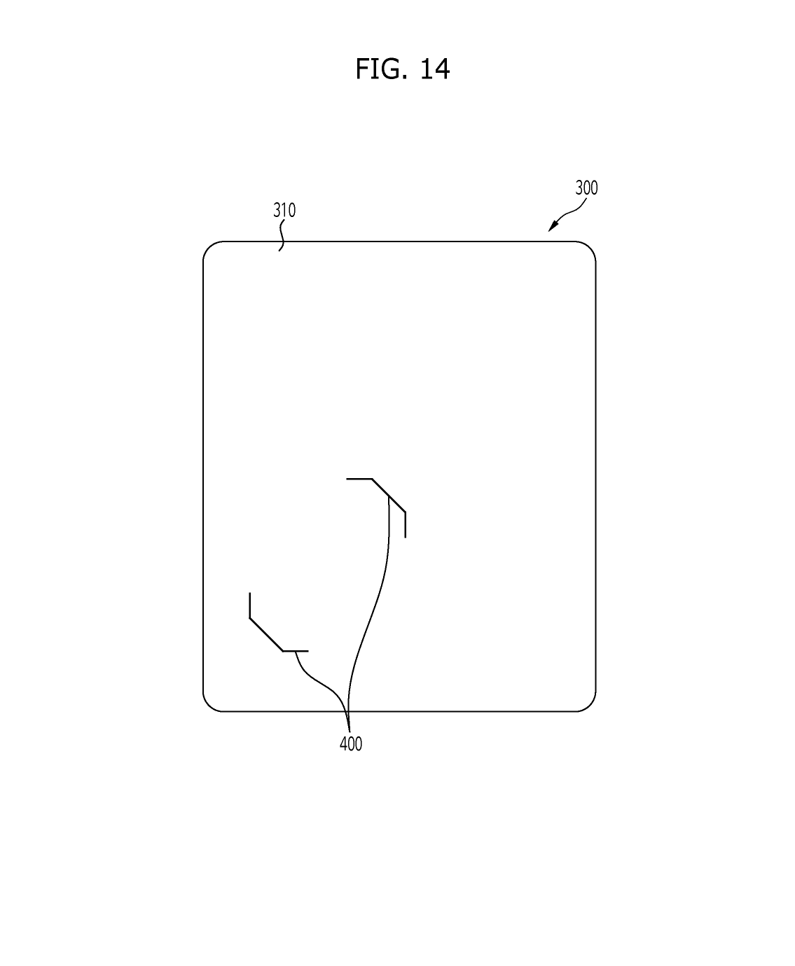

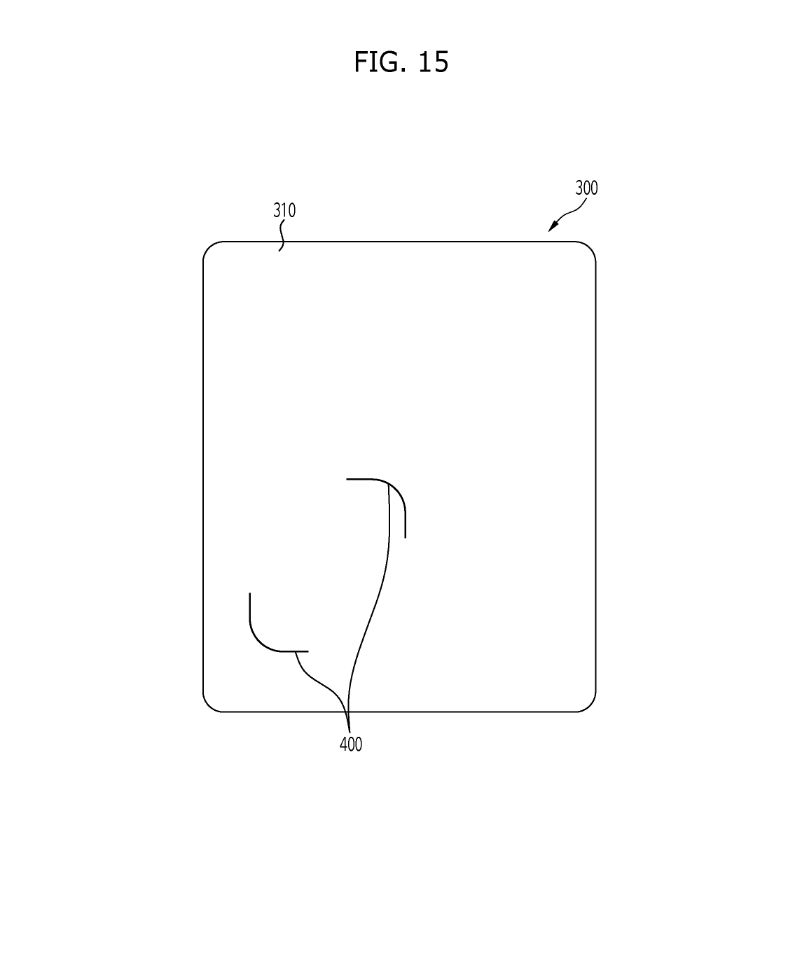

FIG. 10 is a view of another example of notch grooves symmetrically formed on the third surface of the cover according to an embodiment of the present disclosure, FIG. 11 is a view of an example in which a front-view shape of the notch groove is curved according to an embodiment of the present disclosure, FIG. 12 is a view of an example in which a front-view shape of the notch groove is linear according to an embodiment of the present disclosure, FIG. 13 is a view of another example in which a front-view shape of the notch groove is linear according to an embodiment of the present disclosure, FIG. 14 is a view of yet another example in which a front-view shape of the notch groove is linear according to an embodiment of the present disclosure and FIG. 15 is a view of another example in which a front-view shape of the notch groove is curved according to an embodiment of the present disclosure.

In an embodiment, the notch groove 400 may be arranged in plurality at positions that are symmetric with respect to a transverse axis passing through the central portion 330 on the plane of the cover 300. In the example depicted in FIG. 10, eight notch grooves 400 are arranged at positions symmetric with respect to the transverse axis passing through the central portion 330. The plurality of notch grooves 400 may be spaced at predetermined intervals along a straight line extending in the first direction D1 on the plane of the cover 300 or along a straight line extending in the second direction D2 on the plane of the cover 300. The plurality of notch grooves 400 may be formed by notching the third surface 310 of the cover 300 to a predetermined depths that are the same for all of the notch grooves 400.

The plurality of notch grooves 400 may be arranged in a shape that is symmetric with respect to the transverse axis passing through the central portion 330 on the plane of the cover 300 such that the notch grooves 400 simultaneously induce fracture when internal pressure of the secondary battery rises. That is, the notch grooves 400 may be arranged so that identical tensile stress is applied. Thus, a problem can be prevented where the notches that are formed in the sections where tensile stress is relatively concentrated rupture first and release gas but other notches do not rupture, thereby potentially leading to an explosion. The simultaneous fracture prevents such a problem.

The front-view shape of the notch groove 400 may be at least one of a curved shape and a linear shape. For example, as shown in FIG. 11, the front-view shape of the notch groove 400 may be curved, and notch grooves 400 may be disposed at a center area and a side-edge area on the third surface 310 of the cover 300. As shown in FIG. 12, the front-view shape of the notch groove 400 may be an oblique or intersecting straight line, and notch grooves 400 may be disposed at the center area and the side-edge area. As shown in FIG. 13, the front-view shape of the notch groove 400 may be a straight line bent at 90 degrees, and the two notch grooves 400 may be disposed at the center area and the side-edge area. As shown in FIG. 14, the front-view shape of the notch groove 400 may be a straight line bent in two steps, and the notch grooves 400 may be disposed at the center area and the side-edge area. As shown in FIG. 15, the front-view shape of the notch groove 400 may be a curve including straight lines at both ends, and notch grooves 400 may be disposed at the center area and the side-edge area.

The notch grooves 400 depicted in FIGS. 11 to 15 may be configured to simultaneously induce fracture when internal pressure of the secondary battery rises. The notch grooves 400 may be formed by notching the third surface 310 of the cover 300 to the same depths. In other embodiments, the notch grooves 400 may be configured to sequentially induce fracture when internal pressure of the secondary battery rises. In such embodiments, the notch grooves 400 may be formed to different depths in the third surface 310 of the cover 300. Notching depths and fracture pressures of the two notch grooves 400 may be set based on the tensile stress applied to the case for the secondary battery when internal pressure rises.

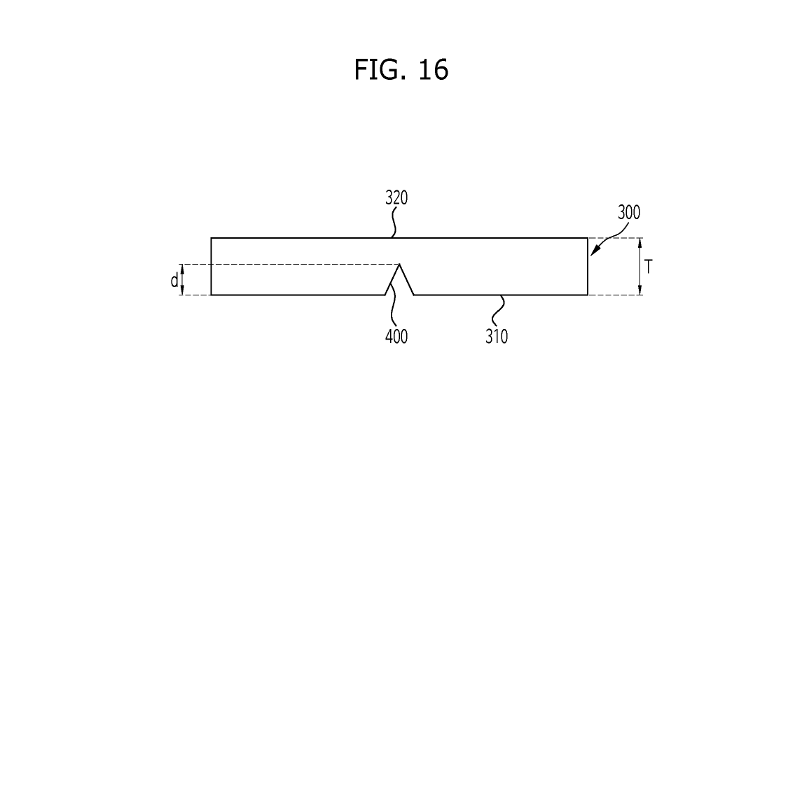

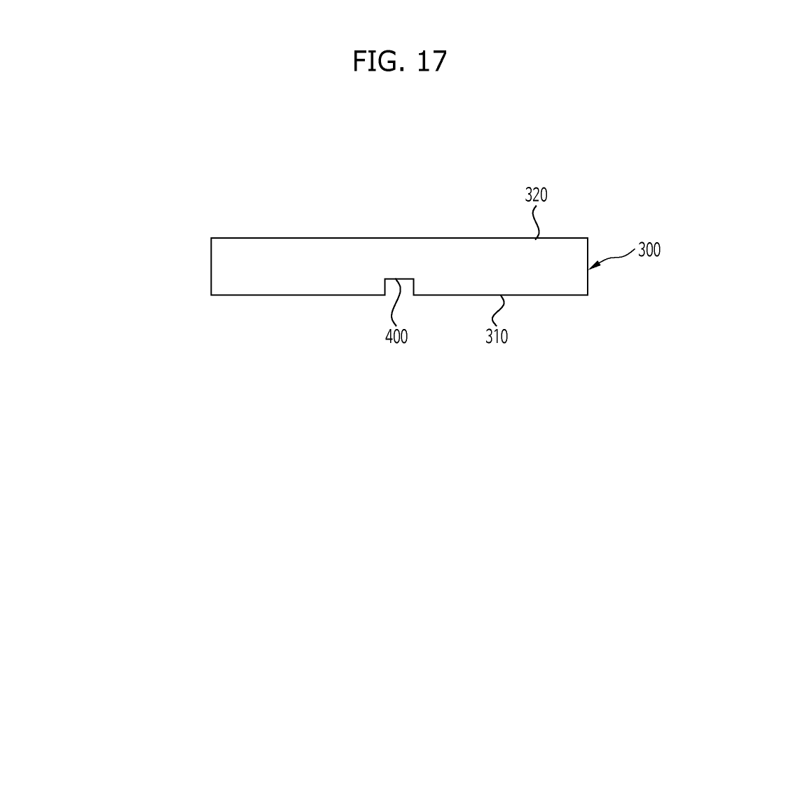

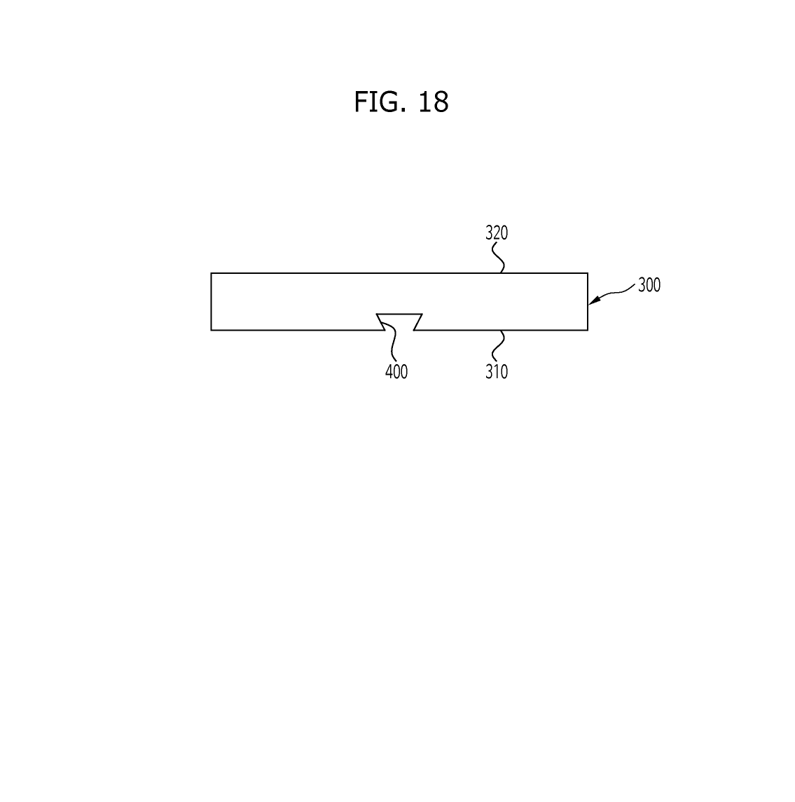

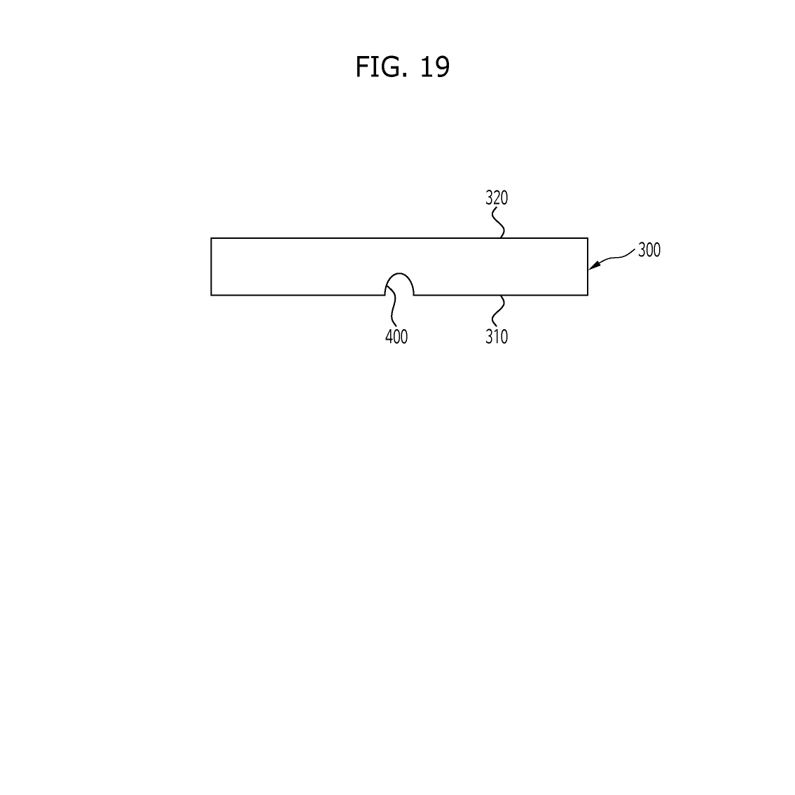

FIG. 16 is a view of the depth of a notch groove, FIG. 17 is a view of a rectangular cross-sectional shape of a notch groove, FIG. 18 is a view a trapezoidal cross-sectional shape of a notch groove, and FIG. 19 is a view of a arcuate cross-sectional shape of a notch groove.

A depth d of the notch groove 400 may be formed to be greater than or equal to 50 percent and less than or equal to 90 percent of the thickness T of the cover 300. The notch groove 400 may be formed by notching in a direction from the third surface 310 toward the fourth surface 320 of the cover 300. When the internal pressure of the secondary battery is greater than or equal to a predetermined pressure, the cover adjacent to an end portion of the notch groove 400 and the fourth surface 320 may fracture. When the depth d of the notch groove 400 is less than 50 percent of the thickness T of the cover 300, the notch groove 400 may not easily induce fracture in response to an internal-pressure increase and thus may fail to perform a venting function. When the depth d of the notch groove 400 exceeds 90 percent of the thickness T of the cover 300, the fracture may occur as the result of a physical impact to the secondary battery or when there is a small internal pressure increase, resulting in a failure to secure the rigidity of the case for the secondary battery itself, and the high-pressure stability may decrease.

In examples of the present disclosure, the cross-sectional shape of the notch groove 400 may be any one of a rectangle, a trapezoid, or an arc. The cross-sectional shape of the notch groove 400 is not limited as long as the shape can effectively induce fracture. For example, as shown in FIG. 17, when the cross-sectional shape of the notch groove 400 is rectangular, a side adjacent to the fourth surface 320 of the cover 300 may elongate and fracture by shear stress. As another example, as shown in FIG. 18, when the cross-sectional shape of the notch groove 400 is trapezoidal, a short side adjacent to the third surface 310 of the cover 300 may elongate, and by shear stress, the fourth surface may also elongate, resulting in the induced fracture of the notch groove 400. As yet another example and as shown in FIG. 19, when the cross-sectional shape of the notch groove 400 is arcuate, shear stress applied from the third surface 310 toward the fourth surface 320 of the cover 300 may be sequentially transferred, thereby minimizing a pressure deviation when the notch groove 400 induces fractures.

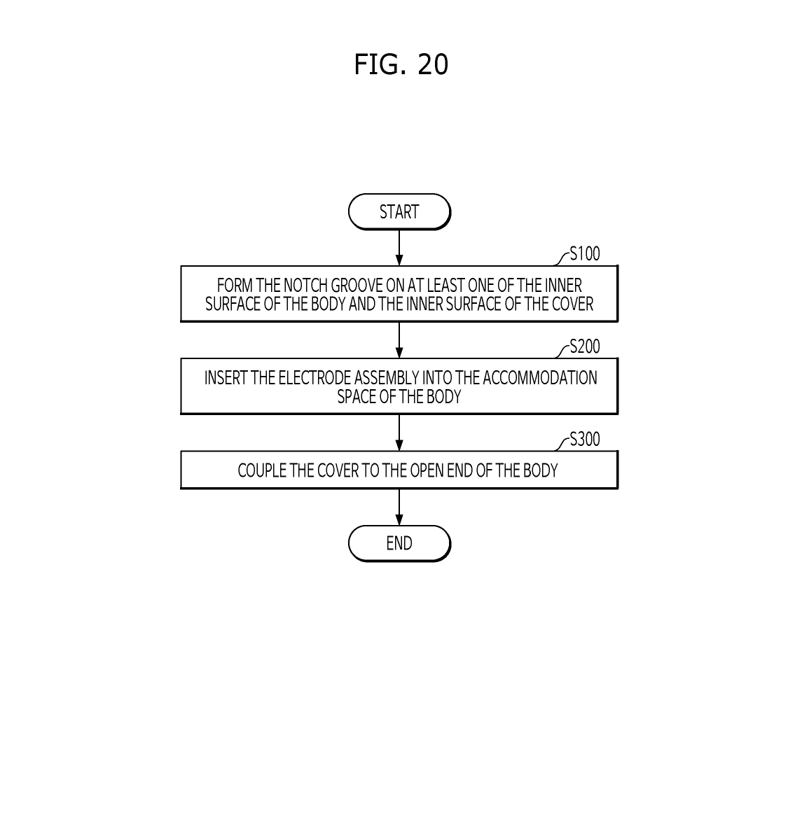

FIG. 20 is a flowchart of the method of manufacturing the secondary battery according to an embodiment.

In an embodiment, the method of manufacturing the secondary battery may start with a step S100 of forming the notch groove in at least one of the covers. In step S100, the notch groove may be formed on at least one of the inner surface of the body and the inner surface of the cover. The body may include a first surface adjacent to the electrode assembly and a second surface opposite the first surface. Step S100 may include notching in a direction from the first surface toward the second surface of the body to form the notch groove on the inner surface of the case.

The cover may include a third surface adjacent to the electrode assembly and a fourth surface opposite to the third surface. Step S100 may include notching in a direction from the third surface toward the fourth surface of the cover to form the notch groove on the inner surface of the cover.

After step S100 of forming the notch groove, step S200 of inserting the electrode assembly into the accommodation space of the body may be performed. After step S200, step S300 of coupling the cover to the open end of the body may be performed.

The flowchart of FIG. 20 and the above description are merely exemplary, and the scope of the present disclosure is not limited to these examples. One or more steps may be added, deleted, or changed in the flowchart and the description, an order of one or more steps may be changed, and one or more steps may be performed simultaneously.

Although the present disclosure has been described with reference to embodiments and drawings illustrating aspects thereof, the present disclosure is not limited thereto. Various modifications and variations may be made by persons skilled in the art within the scope of the technical spirit of the present disclosure.

### DESCRIPTION OF REFERENCE NUMERALS

10: secondary battery

100: electrode assembly

200: body

210: accommodation space

220: first surface

230: second surface

300: cover

310: third surface

320: fourth surface

330: central portion

400: notch groove

What is claimed is:

1. A secondary battery comprising:
a body comprising an accommodation space, with an opening being formed in the body;
an electrode assembly provided in the accommodation spaced of the body, the electrode assembly including a first electrode, a separator, and a second electrode;
a cover coupled to the body to cover the opening; and
a notch groove formed in at least one of an inner surface of the body and an inner surface of the cover,
wherein the notch groove is configured to induce the at least one of the inner surface of the body and the inner surface of the cover to fracture when a predetermined internal pressure of the accommodation space is reached.

2. The secondary battery as claimed in claim 1, wherein the body comprises a first surface adjacent to the electrode assembly and a second surface opposite to the first surface, and the notch groove is formed in the first surface and toward the second surface.

3. The secondary battery as claimed in claim 2, wherein, when an internal pressure of the accommodation space is greater than or equal to the predetermined internal pressure, the body is fractured at an end portion of the notch groove adjacent to the second surface.

4. The secondary battery as claimed in claim 1, wherein the cover comprises a first surface adjacent to the electrode assembly and a second surface opposite to the first surface, and the notch groove is formed in the first surface and toward the second surface.

5. The secondary battery as claimed in claim 4, wherein, when an internal pressure of the accommodation space is greater than or equal to the predetermined internal pressure, the cover is fractured at an end portion of the notch groove adjacent to the second surface.

6. The secondary battery as claimed in claim 1, wherein a cross-sectional shape of the notch groove is a triangle, a rectangle, a trapezoid, or an arc.

7. The secondary battery as claimed in claim 1, wherein the notch groove comprises at least one notch groove formed along a straight line extending in a first direction on a plane of the cover or along a straight line extending in a second direction on the plane of the cover.

8. The secondary battery as claimed in claim 7, wherein the notch groove comprises a plurality of notch grooves arranged at positions that are symmetric with respect to an axis passing through a central portion of the plane of the cover.

9. The secondary battery as claimed in claim 1, wherein a front-view shape of the notch groove is at least one of a curved shape and a linear shape.

10. The secondary battery as claimed in claim 1, wherein a depth of the notch groove is greater than or equal to 50 percent and less than or equal to 90 percent of a thickness of the cover.

11. The secondary battery as claimed in claim 1, wherein the body and the cover are formed of a same metallic material.

12. The secondary battery as claimed in claim 11, wherein the metallic material comprises stainless use steel.

13. A case for a secondary battery comprising:
a body comprising an accommodation space configured to receive an electrode assembly, with an opening being formed in the accommodation space;
a cover coupled to the body to close the opening; and
a notch groove formed in at least one of an inner surface of the body and an inner surface of the cover,
wherein the notch groove is configured to induce the at least one of the inner surface of the body and the inner surface of the cover to fracture when a predetermined internal pressure of the accommodation space is reached.

14. The case as claimed in claim 13, wherein the body comprises a first surface adjacent to the electrode assembly and a second surface opposite to the first surface, and the notch groove is formed in the first surface and toward the second surface.

15. The case as claimed in claim 14, wherein, when the internal pressure of the accommodation space is greater than or equal to a predetermined pressure, the body is fractured at an end portion of the notch groove adjacent to the second surface.

16. The case as claimed in claim 13, wherein the cover comprises a first surface adjacent to the electrode assembly and a second surface opposite to the first surface, and the notch groove is formed in the first surface and toward the second surface.

17. The case as claimed in claim 16, wherein, when the internal pressure of the accommodation space is greater than or equal to a predetermined pressure, the cover is fractured at an end portion of the notch groove adjacent to the second surface.

18. A method of manufacturing a secondary battery comprising:
forming a notch groove in at least one of an inner surface of a body and an inner surface of a cover;
inserting an electrode assembly into an accommodation space of the body; and
coupling the cover to the body to cover an opening formed in the body.

19. The method of claim 18, wherein the body comprises a first surface adjacent to the electrode assembly and a second surface opposite to the first surface, and forming the notch groove comprises notching in a direction from the first surface toward the second surface to form the notch groove in the inner surface of the body.

20. The method of claim 18, wherein the cover comprises a first surface adjacent to the electrode assembly and a second surface opposite to the first surface, and forming the notch groove comprises notching in a direction from the first surface toward the second surface to form the notch groove in the inner surface of the cover.
